(19) United States
(12) Patent Application Publication
(10) Pub. No.: US 2006/0201536 A1
(43) Pub. Date: Sep. 14, 2006

(54) Method for cleaning an industrial part

(76) Inventors: Marty Solcz, Tecumseh (CA); Andrew Noestheden, Tecumseh (CA)

Correspondence Address: GIFFORD, KRASS, GROH, SPRINKLE & CITKOWSKI, P.C, PO BOX 7021, TROY, MI, 48007-7021, US

(21) Appl. No.: 11/074,549

(22) Filed: Mar. 8, 2005

(51) Int. Cl. B08B 5/04; B08B 7/00; B08B 3/00

(52) U.S. Cl. 134/33; 134/34; 134/21

(57) ABSTRACT

A method for cleaning an industrial part, such as crankshafts, engine blocks and the like, following a manufacturing operation after which manufacturing debris, such as oils, shavings, and/or foundry sand, are present on the part. The part is first spun at a speed and for a time period sufficient to eject at least a portion of the debris and oil from the part after the manufacturing operation. Thereafter, the part is washed with a cleaning solution to remove the remaining oil and debris from the part. Optionally, the part is spun dry after being washed with the cleaning solution.

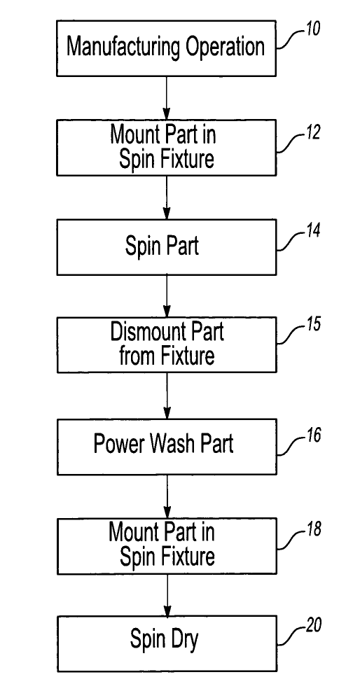

### BACKGROUND OF THE INVENTION

I. Field of the Invention

The present invention relates to a method for cleaning an industrial part following a manufacturing operation.

II. Description of Relevant Art

In the manufacture of machinery, such as the manufacture of automotive engines, it is necessary to clean the parts following the manufacturing operation. Such parts contain not only cutting oils and lubricants from the machining operation, but also machine shavings, coarse sand residue and the like. The failure to integrally remove such debris from each industrial part prior to assembly can result in damage to the engine after assembly of the individual component parts. Furthermore, as used herein, the term “industrial part” means a metallic or plastic component that is subsequently assembled into a machine.

Previously, in order to clean the industrial part of debris, the industrial part was subjected to high pressure liquid sprays which directed a cleaning solution toward the part. After the part was cleaned, the part was typically carried by a conveyor or positioned in a dunnage container and allowed to dry under a forced air dryer.

One disadvantage of this previously known method of cleaning the parts, however, is that oftentimes the cutting oils and shavings would pool in the areas of the industrial part. This, in turn, resulted in pollution of the facility floor when conveying the part from one machining operation to the next, and in premature pollution/saturation of the water-based washing solution.

A still further disadvantage of these previously known methods to clean industrial parts is that, in some cases, the water spray was insufficient to remove all of the manufacturing debris, such as metal shavings, oil and coarse sand, from the part during the cleaning operation, when accumulating in too high quantity. When this happened, the unremoved debris can damage the engine after final assembly.

A still further disadvantage of the previously known methods for cleaning industrial parts is that very high water pressure is employed, particularly when the parts are heavily contaminated. Such high pressure water disadvantageously results in excessive noise and power consumption. Furthermore, such high pressure water sources typically have elevated water temperatures due to the mechanism for producing the high pressure (Joules effect) which in turn heats the parts. When this happens, it may be necessary to cool the washed parts in a refrigerated trough which further increases energy consumption.

### SUMMARY OF THE PRESENT INVENTION

The present invention provides a method for cleaning an industrial part which overcomes the above-mentioned disadvantages of the previously known methods.

In brief, in the method of the present invention, following the manufacturing operation, the part is mounted within a spinning fixture and then spun for a time period and at a speed sufficient to eject at least a portion, and preferably most, of the manufacturing debris and cutting oils from the part.

Following the spinning operation, the part is either conveyed to the next machining operation or subjected to a wash with a cleaning solution which is preferably water based. This cleaning solution is sufficient to remove any remaining manufacturing debris from the industrial part. Both the cleaning solution flow and its pressure can be adjusted to that just necessary, saving initial investment as well as energy cost in production.

Optionally, following the power wash, the part is again mounted within a fixture and then spun at a speed and for a time period sufficient to eject most of the cleaning solution from the part.

In the first alternative, the part is spun, but not washed, between two intermediate manufacturing operations, thereby preventing the pollution of the conveying means and area, and washed only after the final manufacturing operation.

### BRIEF DESCRIPTION OF THE DRAWING

A better understanding of the present invention will be had upon reference to the following description, when read in conjunction with the drawing, which is a flowchart depicting the preferred method of the present invention.

### DETAILED DESCRIPTION OF A PREFERRED METHOD OF THE PRESENT INVENTION

With reference to the drawing, at step 10 the metal part is subjected to a manufacturing operation of some sort. This manufacturing operation can include casting, machining, and/or the like.

Following the manufacturing operation at step 10, manufacturing debris remains on the part. This debris can include sand, cutting oils, metal shavings, and/or the like. Such manufacturing debris must be removed from the part prior to assembly of the part in the final machine.

Following the manufacturing operation at step 10, the part is then mounted in a spin fixture at step 12. The actual construction for the spin fixture will vary from one part to another.

After the part is mounted in a spin fixture at step 12, the part is then spun at step 14 for a time period and at a speed sufficient to eject at least a portion, and preferably most, of the manufacturing debris from the part. In practice, the part is spun at a speed of between 150 and 500 revolutions per minute and for a period of between ten and ninety seconds.

After the spinning operation at step 14, the part is dismounted from the fixture of step 15 and then subjected to a wash at step 16. The wash is accomplished by directing at least one, and preferably several, high velocity jets of cleaning solution onto the part although low pressure, low velocity water jets may alternatively be used. Preferably, the cleaning solution is water based. The washing step at step 16 removes any remaining manufacturing debris from the part. Furthermore, since most of the manufacturing debris is removed during the initial spinning operation, there is a lower risk of remaining contaminant after final washing, and only minimal contamination of the cleaning solution results thereby extending the useful life of the cleaning solution.

Following the washing step 16, the part is then optionally mounted in a spin fixture at step 18 and then spun at step 20 for a time period and at a speed sufficient to eject the cleaning solution from the part through centrifugal force. Preferably, the spin drying at step 20 is at a speed of between 150 and 500 revolutions per minute and between ten and ninety seconds.

In a still further embodiment of the invention, the part is mounted to the spinning fixture and spun, but not washed between intermediate manufacturing operations to only remove most of the manufacturing debris and/or oil from the part. The part is then both spun and washed after the final manufacturing operation to essentially completely clean the part. However, by only spinning, but not washing, the part during intermediate manufacturing operations, it will be a cost-effective way to prevent machining shop pollution and at the end minimize contamination of the wash liquid.

In practice, the method of the present invention is sufficient to remove most manufacturing debris from the part in between two manufacturing operations, and remove essentially all of them after the latest manufacturing operation. Having described my invention, however, many modifications thereto will become apparent to those skilled in the art to which it pertains without deviation from the spirit of the invention as defined by the scope of the appended claims.

I claim:

1. A method for cleaning an industrial part comprising the steps of:
following a manufacturing operation, spinning the part at a speed and for a time period sufficient to eject at least a portion of manufacturing debris from the part resulting from the manufacturing operation,
thereafter power washing the part with a cleaning solution.

2. The method as defined in claim 1 and further comprising the step of spin drying the part following said power washing step.

3. The method as defined in claim 1 wherein said power washing step further comprises the step of directing at least one high velocity fluid stream of cleaning solution onto the part.

4. The method as defined in claim 1 wherein said speed is between 150 and 500 revolutions per minute.

5. The method as defined in claim 1 wherein said period is between ten and ninety seconds.

6. The method as defined in claim 1 wherein said cleaning solution is a water-based cleaning solution.

7. The method as defined in claim 1 and further comprising the step of mounting the part in a spin fixture prior to said spinning step.

8. The method as defined in claim 2 wherein said spin dry step comprises the steps of spinning the part at a speed of between 150 and 500 revolutions per minute and for a period of between ten and ninety seconds.

9. The method as defined in claim 1 and further comprising the step of drying the part by an air dryer.

10. The method as defined in claim 2 and further comprising the step of vacuum drying the part after spin drying it.

11. A method for cleaning an industrial part in which two or more manufacturing operations are performed on the part, the method comprising the steps of:
spinning the part at a speed and for a time sufficient to eject at least a portion of manufacturing debris and cutting oil from the part prior to conveying it to a subsequent manufacturing operation; and
washing the part with a cleaning solution following a final manufacturing operation.

12. The method as defined in claim 1 and further comprising the step of drying the part by a vacuum dryer.
